(19) United States
(12) Patent Application Publication
(10) Pub. No.: US 2026/0045227 A1
(43) Pub. Date: Feb. 12, 2026

(54) DATA DRIVER AND DISPLAY DEVICE INCLUDING THE SAME

(71) Applicant: LG Display Co., Ltd., Seoul (KR)

(72) Inventor: Jeong Ho KANG, Paju-si (KR)

(73) Assignee: LG Display Co., Ltd., Seoul (KR)

(21) Appl. No.: 19/276,956

(22) Filed: Jul. 22, 2025

(30) Foreign Application Priority Data
Aug. 9, 2024 (KR) 10-2024-0107029

(51) Int. Cl. G09G 3/3275

(52) U.S. Cl. CPC G09G 3/3275; G09G 2310/027; G09G 2310/0291; G09G 2320/103; G09G 2330/023; G09G 2370/08; G09G 2370/10

(57) ABSTRACT

A data driver can include a voltage output circuit including a plurality of digital-to-analog converters configured to convert pixel data into analog data voltages, and a plurality of first amplifiers configured to amplify the analog data voltages and output amplified analog data voltages to a plurality of data lines. Also, the data driver can further include a voltage maintenance circuit including a second amplifier configured to amplify a predetermined data voltage into an amplified predetermined data voltage, and output the amplified predetermined data voltage to the plurality of data lines in common, and a selection circuit configured to selectively connect either the voltage output circuit or the voltage maintenance circuit to the plurality of data lines based on a pattern of the pixel data.

### CROSS-REFERENCE TO RELATED APPLICATION

This application claims priority to and the benefit of Korean Patent Application No. 10-2024-0107029, filed in the Republic of Korea on Aug. 9, 2024, the entirety of which is incorporated herein by reference.

### BACKGROUND

### Field

The present disclosure relates to a data driver and a display device including the same.

### Discussion of Related Art

Electroluminescent display devices are divided into inorganic light emitting display devices and organic light emitting display devices according to a material of a light emitting layer. An active-matrix type organic light emitting display device includes an organic light emitting diode (hereinafter referred to as an “OLED”) which emits light by itself (e.g., no backlight needed), and has advantages in that a response speed is fast and luminous efficiency, luminance, and a viewing angle are large.

In organic light-emitting display devices, organic light-emitting diodes (referred to as “OLEDs”) are formed in each of the pixels. These organic light-emitting display devices not only respond quickly and have excellent light-emitting efficiency, luminance, and viewing angle, but also have excellent contrast ratio and color reproduction rate because they can express black tones as complete black (e.g., true black or pure black).

Some display devices, for example, a liquid crystal display device or an organic light emitting display device, include a display panel including a plurality of sub-pixels, a driver outputting a driving signal for driving the display panel, a power supply generating power to be supplied to the display panel or the driver, and the like. The driver includes a gate driver that supplies a gate signal, such as a scan signal and emission signal to the display panel, and a data driver that supplies a data signal to the display panel.

In this situation, the data driver adjusts the magnitude of the output voltage according to the pattern of the input image; in particularly, the output voltage fluctuates continuously when a dynamic image such as a moving image is input, while it remains constant when a static image such as a still image is input.

However, regardless of the pattern of the input image, a constant bias current is continuously applied to the output portion of the data driver, thus requiring additional measures to reduce current consumption.

Thus, a need exists for a device having a configuration that can reduce power consumption in a display device while maintaining stable operation.

### SUMMARY OF THE DISCLOSURE

The present disclosure is directed to solving all the above-described necessity and problems.

The present disclosure provides a data driver that can reduce current consumption and a display device including the same.

It should be noted that objects of the present disclosure are not limited to the above-described objects, and other objects of the present disclosure will be apparent to those skilled in the art from the following descriptions.

A data driver according to embodiments of the present disclosure can include a voltage output circuit including a plurality of digital to analog (DA) converters each configured to convert pixel data into a data voltage of analog form and a plurality of first amplifiers configured to amplify the converted data voltage and to output the amplified converted data voltage to each of a plurality of data lines; a voltage maintenance circuit including a single second amplifier configured to amplify a predetermined data voltage and to commonly output the amplified predetermined data voltage to the plurality of data lines; and a selection circuit configured to selectively connect either the voltage output circuit or the voltage maintenance circuit to the plurality of data lines according to a pattern of the pixel data.

A display device according to embodiments of the present disclosure can include a pixel array in which a plurality of data lines, a plurality of gate lines, and a plurality of pixel circuits are arranged; a data driver configured to output data voltages to the plurality of data lines; a gate driver configured to output gate signals to the plurality of gate lines; and a timing controller configured to control the data driver and the gate driver, in which the data driver includes a voltage output circuit including a plurality of DA converters each configured to convert pixel data into a data voltage of analog form and a plurality of first amplifiers each configured to amplify the converted data voltage and to output the amplified converted data voltage to each of a plurality of data lines; a voltage maintenance circuit including a single second amplifier configured to amplify a predetermined data voltage and to commonly output the amplified predetermined data voltage to the plurality of data lines; and a selection circuit configured to selectively connect either the voltage output circuit or the voltage maintenance circuit to the plurality of data lines according to a pattern of the pixel data.

Accordingly to an embodiment of the present disclosure, the data driver is designed to include a voltage output circuit having a plurality of first amplifiers and a voltage maintenance circuit having a single second amplifier, such that either the voltage output circuit or the voltage maintenance circuit is connected to the data lines according to the pattern of the pixel data, thereby allowing the bias current applied to the amplifiers to be adjusted to reduce current consumption.

According to an embodiment of the present disclosure, low-power operation can be possible because the current consumption of the amplifier is reduced.

The effects of the present specification are not limited to the above-mentioned effects, and other effects that are not mentioned will be apparently understood by those skilled in the art from the following description and the appended claims.

### BRIEF DESCRIPTION OF THE DRAWINGS

The above and other objects, features, and advantages of the present disclosure will become more apparent to those of ordinary skill in the art by describing example embodiments thereof in detail with reference to the attached drawings, in which:

FIG. 1 is a block diagram showing a display device according to an embodiment of the present disclosure;

FIG. 2 is a diagram showing the configuration of a data driver according to an embodiment of the present disclosure;

FIGS. 3 to 5 are diagrams for explaining the operation principle of the switch part shown in FIG. 2 according to an embodiment of the present disclosure;

FIG. 6 is a diagram showing the configuration of a data driver according to an embodiment of the present disclosure;

FIGS. 7 to 8 are diagrams for explaining the operation principle of the switch part shown in FIG. 6 according to an embodiment of the present disclosure;

FIGS. 9 to 11 are diagrams for explaining the operation principle of the second driving mode according to an embodiment of the present disclosure;

FIGS. 12 to 13 are diagrams for explaining a situation in which the second driving mode is initiated according to an embodiment of the present disclosure; and

FIGS. 14 to 15 are diagrams for explaining a situation in which the first driving mode is initiated according to an embodiment of the present disclosure.

### DETAILED DESCRIPTION OF THE EMBODIMENTS

Advantages and features of the present specification and methods of achieving them will become apparent with reference to preferable embodiments, which are described in detail, in conjunction with the accompanying drawings. However, the present specification is not limited to the embodiments to be described below and can be implemented in different forms, the embodiments are only provided to completely disclose the present disclosure and completely convey the scope of the present disclosure to those skilled in the art, and the present specification is defined by the disclosed claims.

Since the shapes, sizes, proportions, angles, numbers, and the like disclosed in the drawings for describing the embodiments of the present disclosure are only examples, the present disclosure is not limited to the illustrated items. The same reference numerals indicate the same components throughout the specification. Further, in describing the present disclosure, when it is determined that a detailed description of related known technology can unnecessarily obscure the gist of the present disclosure, the detailed description thereof will be omitted.

When “including,” “having,” “consisting,” and the like mentioned in the present specification are used, other parts can be added unless “only” is used. A situation in which a component is expressed in a singular form includes a plural form unless explicitly stated otherwise.

In interpreting the components, it should be understood that an error range is included even when there is no separate explicit description.

In the situation of a description of a positional relationship, for example, when the positional relationship of two parts is described as “on,” “at an upper portion,” “at a lower portion,” “next to,” and the like, one or more other parts can be located between the two parts unless “immediately” or “directly” is used.

Although first, second, and the like are used to describe various components, these components are not limited by these terms. These terms are only used to distinguish one component from another. Accordingly, a first component, which is mentioned, below can also be a second component within the technical spirit of the present disclosure.

The same reference numerals can refer to substantially the same elements throughout the present disclosure.

The following embodiments can be partially or entirely bonded to or combined with each other and can be linked and operated in technically various ways. The embodiments can be carried out independently of or in association with each other. Also, the term “can” used herein includes all meanings and definitions of the term “may.”

Hereinafter, various embodiments of the present disclosure will be described in detail with reference to the accompanying drawings.

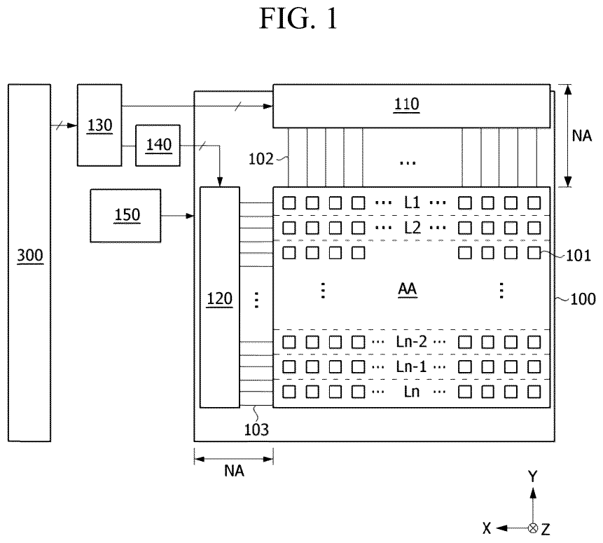

FIG. 1 is a block diagram showing a display device according to an embodiment of the present disclosure.

Referring to FIG. 1, the display device according to an embodiment of the present disclosure includes a display panel 100, and a display panel driving circuit for writing pixel data to pixels of the display panel 100. Additionally, the display device includes a power supply 150.

The display panel 100 can be, but not limited to, a panel having a rectangular structure with a length in the X-axis direction, a width in the Y-axis direction, and a thickness in the Z-axis direction. For example, the display panel 100 can be a heterogeneous panel of which at least a portion is curved or elliptical.

The display area AA of the display panel 100 includes a pixel array to display an input image. The pixel array includes a plurality of data lines 102, a plurality of gate lines 103 crossing the data lines 102, and pixels 101 arranged in a matrix form. The display panel 100 can further include power lines commonly connected to the pixels. The power lines can be commonly connected to pixel circuits to supply a voltage required for driving pixels 101 to the pixels 101.

Each of the pixels 101 can be divided into a red sub-pixel, a green sub-pixel, and a blue sub-pixel for color implementation. Each pixel can further include a white sub-pixel. Each sub-pixel includes a pixel circuit for driving a light emitting element. The light emitting element can include an OLED or an inorganic light emitting diode (LED). Each pixel circuit is connected to the data lines, the gate lines, and the power lines. In the following description, a pixel can be interpreted as a sub-pixel.

The display area AA includes a plurality of pixel lines L1 to Ln. Each of the pixel lines L1 to Ln includes one line of pixels arranged along the line direction (X-axis direction) in the pixel array of the display panel 100. Those pixels arranged in one pixel line share the gate lines 103. The sub-pixels arranged in the column direction Y along the data line direction share the same data line 102. One horizontal period is a time obtained by dividing one frame period by the total number of pixel lines L1 to Ln.

The display panel 100 can be implemented with a non-transmissive display panel or a transmissive display panel. The transmissive display panel can be applied to a transparent display device in which an image is displayed on the screen and a real object in the background is visible (e.g., a viewer can see through the transmissive display panel to view objects on the other side). The display panel 100 can be made of a flexible display panel.

The power supply 150 receives an input voltage applied from the host system 300 and outputs a voltage needed to drive the pixels 101 of the display panel 100 and the display panel driving circuit. To this end, the power supply 150 can include a direct current to direct current converter (DC-DC converter). The DC-DC converter can include a charge pump, a regulator, a buck converter, a boost converter, and the like. The power supply 150 can output a constant voltage (or direct current voltage), such as gate-on voltage, gate-off voltage, pixel driving voltage, cathode voltage, reference voltage, IC driving voltage of the display panel driving circuit, through the DC-DC converter. The gate-on voltage and the gate-off voltage can be supplied to the level shifter 140 and the gate driver 120. Voltages such as pixel driving voltage, cathode voltage, and reference voltage can be supplied to the pixels 101 through the power lines commonly connected to the pixels 101.

The power supply 150 can further include a gamma voltage generator. The gamma voltage generator receives a high-potential reference voltage and a low-potential reference voltage and outputs a plurality of gamma reference voltages divided at specific intervals on a preset gamma curve, for example, a 2.2 gamma curve. The gamma reference voltages are supplied to the data driver 110. In the data driver 110, the gamma reference voltages are subdivided by a voltage dividing circuit into grayscale voltages.

The display panel driving circuit writes pixel data of the input image to the pixels 101 under the control of the timing controller 130. The display panel driving circuit includes a data driver 110 and a gate driver 120.

The display panel driving circuit can further include a touch sensor driver for driving touch sensors. The data driver 110 and the touch sensor driver can be integrated into one source drive integrated circuit (IC).

The data driver 110 receives pixel data of the input image as a digital signal from the timing controller 130 and outputs a data voltage. The data driver 110 can receive gamma reference voltages and generate gamma compensation voltages for each grayscale through a voltage dividing circuit. The per-grayscale gamma compensation voltages are supplied to a digital to analog converter (hereinafter referred to as “DAC”) disposed in each channel of the data driver 110.

The data driver 110 samples and latches digital data received from the timing controller 130 and then inputs the digital data to the DAC. Here, the digital data includes pixel data of the input image. The DAC converts the pixel data into a gamma compensation voltage and outputs a data voltage of the pixel data.

The data driver 110 can be configured to include a voltage output circuit for outputting a data voltage of pixel data for each output channel, a voltage maintenance circuit for outputting a predetermined data voltage to all output channels, and a selection circuit for selecting between the voltage output circuit and the voltage maintenance circuit. The data driver 110 can be selectively driven in a first driving mode that drives the voltage output circuit and a second driving mode that drives the voltage maintenance circuit. For example, the first driving mode can be used for displaying dynamic images (e.g., videos or changing content), and the second driving mode can be a low power mode when a voltage maintenance circuit is active for displaying static images (e.g., still photos or unchanging user interface elements and menus).

The gate driver 120 can be formed on the display panel 100 together with the circuit elements and wiring lines of the display area AA. The gate driver 120 can be disposed in at least one of left and right non-display areas NA outside the display area AA in the display panel 100 or at least a part thereof can be disposed within the display area AA.

The gate driver 120 sequentially outputs pulses of the gate signals to the gate lines 103 under the control of the timing controller 130. The gate driver 120 can sequentially supply the gate signals to the gate lines 103 by shifting the pulses of the gate signals.

The timing controller 130 receives digital video data of an input image and a timing signal synchronized with this data from the host system 300. The timing signal can include a vertical synchronization signal Vsync, a horizontal synchronization signal Hsync, and a data enable signal DE. Since the vertical period and horizontal period can be determined by counting the data enable signal DE, the vertical synchronization signal Vsync and the horizontal synchronization signal Hsync can be omitted. The horizontal synchronization signal Hsync and the data enable signal DE have a periodicity of 1 horizontal period (1H).

The timing controller 130 can control the display panel driving circuit by generating a data timing control signal for controlling the operation timing of the data driver 110 and a gate timing control signal for controlling the operation timing of the gate driver 120 based on the timing signals Vsync, Hsync, DE received from the host system 300. The timing controller 130 can synchronize the data driver 110 and the gate driver 120 by controlling the operation timing of the display panel driving circuit.

The gate timing control signal output from the timing controller 130 can be input to the shift register of the gate driver 120 through the level shifter 140. The level shifter 140 can convert a voltage of the gate timing control signal received from the timing controller 130 to a swing width between the gate-on voltage and the gate-off voltage and supply it to the gate driver 120.

The timing controller 130 can analyze the pattern of the pixel data and transmit mode information to the data driver 110 to drive the data driver 110 in either the first driving mode or the second driving mode according to the analysis result. Here, the first driving mode can be a mode in which a plurality of data voltages output through the voltage output circuit of the data driver 110 are output to each of a plurality of data lines (e.g., for displaying dynamic images), and the second driving mode can be a mode in which one predetermined data voltage output through the voltage maintenance circuit of the data driver 110 is commonly output to the plurality of data lines (e.g., for displaying static images).

The host system 300 can include a main board of one of a television system, a set-top box, a navigation system, a personal computer (PC), a vehicle system, a mobile terminal, and a wearable terminal. The host system 300 can scale or upsample an image signal from a video source according to the resolution of the display panel 100, and can transmit it to the timing controller 130 together with the timing signals.

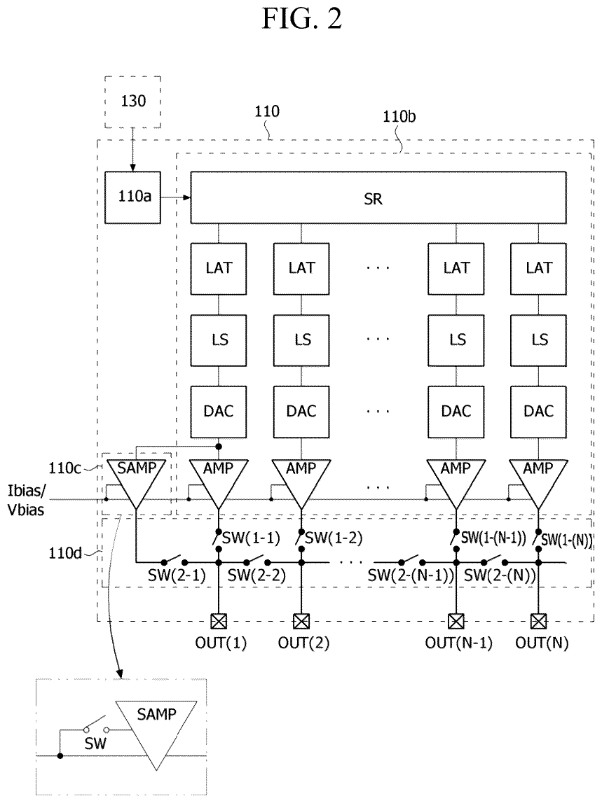

FIG. 2 is a diagram showing the configuration of a data driver according to a first embodiment of the present disclosure.

Referring to FIG. 2, the data driver 110 according to the first embodiment of the present disclosure can include a control circuit 110a, a voltage output circuit 110b, a voltage maintenance circuit 110c, and a selection circuit 110d. The data driver 110 described here can be applied to an organic light emitting display device, but is not limited thereto.

The control circuit 110a can control one of the voltage output circuit 110b or the voltage maintenance circuit 110c to be connected to the data lines based on the data transmitted from the timing controller. The control circuit 110a controls either the voltage output circuit 110b or the voltage maintenance circuit 110c to be connected to the data lines according to the mode information included in the data.

When either the voltage output circuit 110b or the voltage maintenance circuit 110c is connected to the data lines, the control circuit 110a controls the bias current Ibias or bias voltage Vbias to be applied to or blocked from first amplifiers AMP of the voltage output circuit 110b and a second amplifier SAMP of the voltage maintenance circuit 110c.

For example, a switch element SW can be configured to apply or supply bias current Ibias and/or bias voltage Vbias to the second amplifier SAMP, and the second amplifier SAMP can be activated or deactivated by turning on/off the switch element SW by the control of the control circuit 110a, but is not necessarily limited to this configuration.

In this drawing, only the configuration where the switch element SW is connected to the second amplifier SAMP is illustrated as an example; however the first amplifiers AMP can also be similarly configured.

The voltage output circuit 110b can include a shift register SR, latches LAT, digital-to-analog (DA) converters DAC, and first amplifiers AMP. The voltage output circuit 110b can further include level shifters LS.

The shift register SR can shift a clock input from the timing controller to generate a sampling clock, and can sequentially output the generated sampling clock to the latches LAT.

The latches LAT can sample and store pixel data of the input image according to the timing of the sequentially input sampling clock, and can simultaneously output the stored pixel data.

The level shifters LS can convert the voltage level of the stored pixel data. The level shifters LS can convert the voltage level of the pixel data into a voltage level that can drive the DA converters DAC.

The DA converters DAC can convert the pixel data output from the latches LAT or the pixel data whose voltage level has been converted by the level shifters LS into an analog form.

The first amplifiers AMP can amplify the voltage level of the pixel data in analog form, and can output the pixel data with the amplified voltage level to the corresponding data lines through the output terminals. According to an embodiment, the input and output voltage values of the first amplifiers AMP can be substantially the same. For example, each of the first amplifiers AMP can have the function of an output buffer as a buffer circuit.

The voltage maintenance circuit 110c can include the second amplifier SAMP. The second amplifier SAMP is connected to the output terminal of the DA converter DAC in the voltage output circuit 110b, and can amplify the voltage level of the pixel data in analog form input from the DA converter DAC, and can output the pixel data with the amplified voltage level to all data lines through the output terminals. According to an embodiment, the input and output voltage values of the second amplifier SAMP can be substantially the same. For example, the second amplifier SAMP can have the function of an output buffer as a buffer circuit.

In order to connect a plurality of first amplifiers AMP or a single second amplifier SAMP to the output channels OUT(1), OUT(2), . . . , OUT(N−1), and OUT(N), the size of the second amplifier SAMP can be designed to be larger than the first amplifiers AMP in the voltage output circuit 110b (e.g., SAMP>AMP). Because the size of the second amplifier SAMP is formed larger than the size of the first amplifiers AMP in the voltage output circuit, the output current range of the second amplifier SAMP can also be formed larger than the output current range of the first amplifiers AMP. For example, the amplifier used in the static image display mode (e.g., SAMP) can be designed to handle or deliver a wider range of electrical current compared to each of the individual amplifiers (AMP) used in the dynamic image display mode. Accordingly, the second amplifier SAMP can adequately drive the combined load of all the data lines it is connected to during the static mode or low power mode, and maintain the required stable voltage level across these lines effectively.

The selection circuit 110d can connect the output channels to the voltage output circuit 110b according to the first driving mode (e.g., dynamic image mode), and can connect the output channel to the voltage maintenance circuit according to the second driving mode (e.g., low power mode/static image mode).

The selection circuit 110d can include first switch parts SW(1-1), SW(1-2), . . . , SW(1-(N−1)), and SW(1-(N)) and second switch parts SW(2-1), SW(2-2), . . . , SW(2-(N−1)), and SW(2-(N)).

The first switch parts SW(1-1), SW(1-2), . . . , SW(1-(N−1)), and SW(1-(N)) can connect a plurality of output terminals of the voltage output circuit to the data lines for each corresponding output channel. Each of the switches included in the first switch parts SW(1-1), SW(1-2), . . . , SW(1-(N−1)), and SW(1-(N)) can connect or block between the output terminal of the first amplifier in the voltage output circuit and its corresponding data line.

The second switch parts SW(2-1), SW(2-2), . . . , SW(2-(N−1)), and SW(2-(N)) can connect a single output terminal of the voltage maintenance circuit to the data lines for all output channels. Each of the switches included in the second switch parts SW(2-1), SW(2-2), . . . , SW(2-(N−1)), and SW(2-(N)) can connect or block between the output terminal of the second amplifier in the voltage maintenance circuit and the data line, as well as between the data lines.

In the first driving mode, the first switch parts SW(1-1), SW(1-2), . . . , SW(1-(N−1)), and SW(1-(N)) can be turned on, and the second switch parts SW(2-1), SW(2-2), . . . , SW(2-(N−1)), and SW(2-(N)) can be turned off. In the second driving mode, the second switch parts SW(2-1), SW(2-2), . . . , SW(2-(N−1)), and SW(2-(N)) can be turned on, and the first switch parts SW(1-1), SW(1-2), . . . , SW(1-(N−1)), and SW(1-(N)) can be turned off. The first switch parts SW(1-1), SW(1-2), . . . , SW(1-(N−1)), and SW(1-(N)) and the second switch parts SW(2-1), SW(2-2), . . . , SW(2-(N−1)), and SW(2-(N)) can be turned on or turned off simultaneously. In other words, the selection circuit 110d can employ two distinct sets of switches to determine how N data lines are driven. One set of switches (e.g., first switch parts SW(1-1) through SW(1-N)), can connect the outputs from a voltage output circuit to their corresponding data lines, which can used during a first driving mode for dynamic images. The other set of switches (e.g., second switch parts SW(2-1) through SW(2-N)), can connect a single output terminal from a voltage maintenance circuit to these data lines during a second driving mode (e.g., for static images). The selection circuit 110d can operate by turning the first switch parts on and the second off in the first mode, and conversely turning the second switch parts on and the first switch parts off in the second mode, in which this switchover can happen simultaneously.

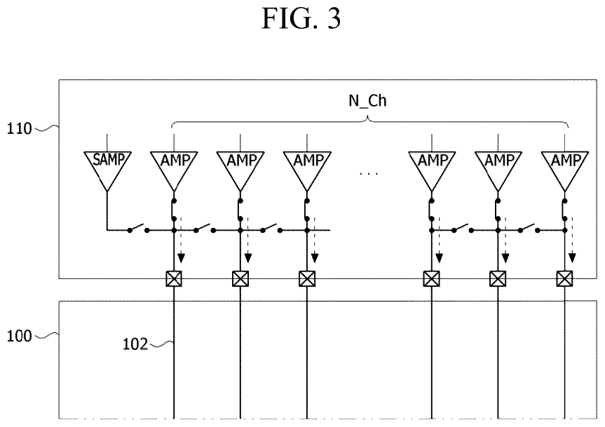

FIGS. 3 to 5 are diagrams for explaining the operation principle of the switch part shown in FIG. 2 according to an embodiment of the present disclosure.

Referring to FIG. 3, during the first driving mode (e.g., dynamic image mode), the control circuit 110a can turn on the first switch parts and turn off the second switch parts, so that the output terminals of the first amplifiers in the voltage output circuit can be connected to the corresponding data lines.

At this time, the control circuit 110a can block the bias current and/or bias voltage applied to the second amplifier SAMP in the voltage maintenance circuit to deactivate the second amplifier SAMP (e.g., SAMP is off during the first driving mode, and AMPs are on).

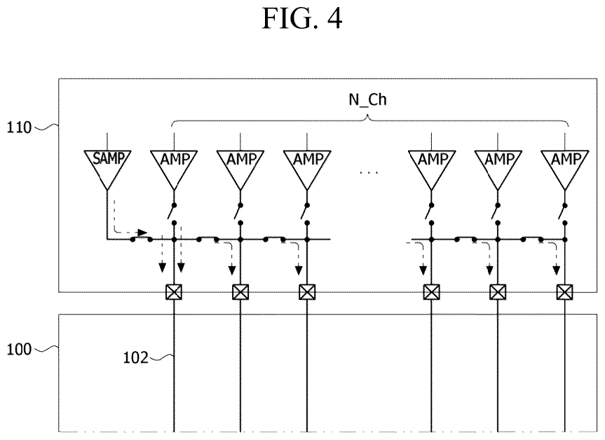

Referring to FIG. 4, during the second driving mode (e.g., lower power mode/static image mode), the control circuit 110a can turn on the second switch parts and turn off the first switch parts, so that a single output terminal of the voltage maintenance circuit can be connected to all data lines (e.g., SAMP is on during the second driving mode, and AMPs are off).

At this time, the control circuit 110a can block the bias current and/or bias voltage applied to all first amplifiers AMP in the voltage output circuit to deactivate all first amplifiers AMP.

As described above, a switch element can be configured to apply or supply bias current and/or bias voltage to the first amplifiers AMP and the second amplifier SAMP, and the first amplifiers AMP and the second amplifier SAMP can be activated or deactivated by turning on/off the switch element, but is not necessarily limited to this configuration.

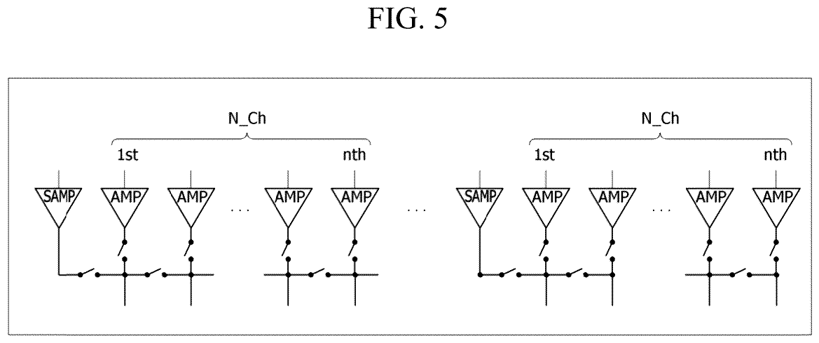

Referring to FIG. 5, according to an embodiment, the data driver can configure one voltage maintenance circuit for a predetermined number of channels, such as a group of channels N_Ch including the first channel 1st to the nth channel nth in FIG. 5. For example, the predetermined number of channels can be 80 channels, but is not limited thereto and can be changed as needed (e.g., one SAMP per 40 channels, or one SAMP for every 120 channels, etc.).

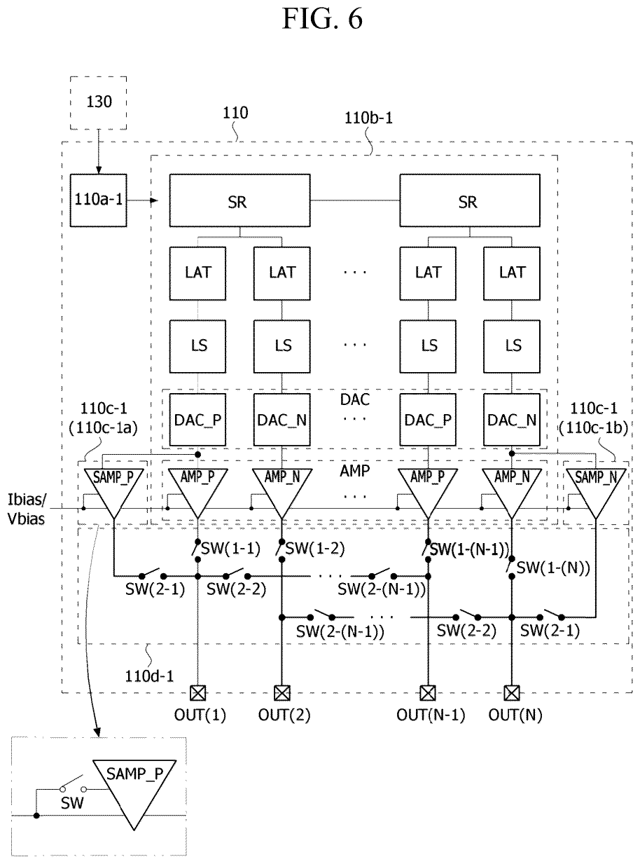

FIG. 6 is a diagram showing the configuration of a data driver according to a second embodiment of the present disclosure.

Referring to FIG. 6, the data driver 110 according to the second embodiment of the present disclosure can include a control circuit 110a-1, a voltage output circuit 110b-1, a voltage maintenance circuit 110c-1, and a selection circuit 110d-1. The data driver 110 described here can be applied to a liquid crystal display device.

The control circuit 110a-1 can perform control so that one of the voltage output circuit 110b-1 and the voltage maintenance circuit 110c-1 is connected to the data lines based on the EPI data transmitted from the timing controller.

When either the voltage output circuit 110b-1 or the voltage maintenance circuit 110c-1, which includes voltage maintenance circuits 110c-1a and 110c-1b, is connected to the data lines, the control circuit 110a-1 controls the bias current Ibias or bias voltage Vbias to be applied to or blocked from the first amplifiers AMP_P and AMP_N of the voltage output circuit 110b-1 and the second amplifiers SAMP_P and SAMP_N of the voltage maintenance circuits 110c-1a and 110c-1b. In other words, the control circuit (110a-1) can selectively apply or block bias current (Ibias) or bias voltage (Vbias) to first amplifiers (AMP_P, AMP_N) within the voltage output circuit (110b-1) and to second amplifiers (SAMP_P, SAMP_N) within associated voltage maintenance circuits (110c-1a, 110c-1b), based on whether the voltage output circuit or the main voltage maintenance circuit is operatively connected to the data lines.

For example, a switch element SW can be configured to apply or supply bias current Ibias and/or bias voltage Vbias to the second amplifier SAMP_P, and the second amplifier SAMP_P can be activated or deactivated by turning on/off the switch element SW by the control of the control circuit 110a-1, but is not necessarily limited to this configuration.

In this drawing, only the configuration where the switch element SW is connected to the second amplifier SAMP_P is illustrated as an example; however, the second amplifier SAMP_N and the first amplifiers AMP can also be similarly configured.

The voltage output circuit 110b-1 can include shift registers SRs, latches LAT, level shifters LS, DA converters DAC, and first amplifiers AMP.

The shift register SR can shift a clock input from the timing controller to generate a sampling clock, and can sequentially output the generated sampling clock to the latches LAT.

The latches LAT can sample and store pixel data of the input image according to the timing of the sequentially input sampling clock, and can simultaneously output the stored pixel data.

The level shifters LS can convert the voltage level of the stored pixel data. The level shifters LS can convert the voltage level of the pixel data to a voltage level that can drive the DA converter DAC.

The DA converters DAC can convert the image data with converted voltage level into an analog form. The DA converters DAC can include a positive DA converter DAC_P and a negative DA converter DAC_N.

The positive DA converter DAC_P can convert the pixel data with converted voltage level into a positive (+) data voltage in analog form, and the negative DA converter DAC_N can convert the pixel data with converted voltage level into a negative (−) data voltage.

The first amplifiers AMP can amplify the voltage level of the image data in analog form, and can output the image data with the amplified voltage level to the corresponding data lines through the output terminals. The first amplifiers AMP can include positive amplifiers AMP_P and negative amplifiers AMP_N. The positive amplifiers AMP_P and the negative amplifiers AMP_N can be alternately arranged. For example, the positive amplifiers AMP_P can be arranged to be connected to odd-numbered data lines, and the negative amplifiers AMP_N can be arranged to be connected to even-numbered data lines.

The positive amplifiers AMP_P can amplify the voltage level of the pixel data in analog form to generate positive data voltages and output them to the corresponding data lines through the output terminals.

The negative amplifiers AMP_Ns can amplify the voltage level of the pixel data in analog form to generate negative data voltages and output them to the corresponding data lines through the output terminals.

The voltage maintenance circuit 110c-1 can include a positive voltage maintenance circuit 110c-1a and a negative voltage maintenance circuit 110c-1b.

The positive voltage maintenance circuit 110c-1a can include a positive second amplifier SAMP_P. The positive second amplifier SAMP_P is connected to the output terminal of the positive DA converter DAC_P in the voltage output circuit 110b-1, and it can amplify the voltage level of the pixel data in analog form input from the positive DA converter DAC_P, and can output the pixel data with the amplified voltage level to all data lines through the output terminals.

The negative voltage maintenance circuit 110c-1b can include a negative second amplifier SAMP_N. The negative second amplifier SAMP_N is connected to the output terminal of the negative DA converter DAC_N in the voltage output circuit 110b-1, and it can amplify the voltage level of the pixel data in analog form input from the negative DA converter DAC_N, and can output the pixel data with the amplified voltage level to all data lines through the output terminals.

The selection circuit 110d-1 can connect the output channels to the voltage output circuit according to the first driving mode (e.g., dynamic driving mode), and can connect the output channels to the voltage maintenance circuit according to the second driving mode (e.g., low power/static driving mode).

The selection circuit 110d-1 can include first switch parts SW(1-1), SW(1-2), . . . , SW(1-(N−1)), and SW(1-(N)) and second switch parts SW(2-1), SW(2-2), . . . , SW(2-(N−1)).

The first switch part SW(1-1), SW(1-2), . . . , SW(1-(N−1)), and SW(1-(N)) can connect the output terminals of the first amplifiers in the voltage output circuit to the corresponding data lines. Each of the switches included in the first switch part SW(1-1), SW(1-2), . . . , SW(1-(N−1)), and SW(1-(N)) can connect or block between the output terminal of the first amplifier of the voltage output circuit and the corresponding data line.

The second switch part SW(2-1), SW(2-2), . . . , SW(2-(N−1)) can connect output terminals (such as the single output terminal of the positive second amplifier SAMP_P and the single output terminal of negative second amplifier SAMP_N) of the second amplifier of the voltage maintenance circuit to all data lines. For example, the second switches (e.g., SW(2-1) through SW(2-N)) can distribute the single output from the voltage maintenance circuit's second amplifier SAMP to all N data lines, by individually connecting each data line to this common output terminal. Each of the switches included in the second switch part SW(2-1), SW(2-2), . . . , SW(2-(N−1)) can connect or block between the output terminal of the second amplifier in the voltage maintenance circuit and the data line, as well as between the data lines.

In the first driving mode (e.g., dynamic driving mode), the first switch part SW(1-1), SW(1-2), . . . , SW(1-(N−1)), and SW(1-(N)) can be turned on, and the second switch part SW(2-1), SW(2-2), . . . , SW(2-(N−1)) can be turned off. In the second driving mode, the second switch part SW(2-1), SW(2-2), . . . , SW(2-(N−1)) can be turned on and the first switch part SW(1-1), SW(1-2), . . . , SW(1-(N−1)), and SW(1-(N)) can be turned off. The first switch part SW(1-1), SW(1-2), . . . , SW(1-(N−1)), and SW(1-(N)) and the second switch part SW(2-1), SW(2-2), . . . , SW(2-(N−1)) can be turned on or turned off simultaneously.

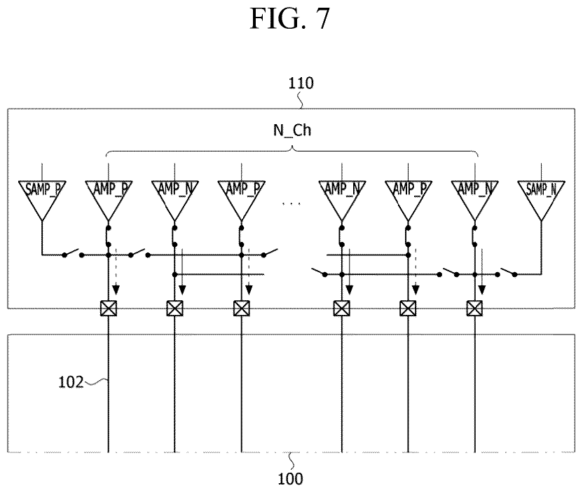

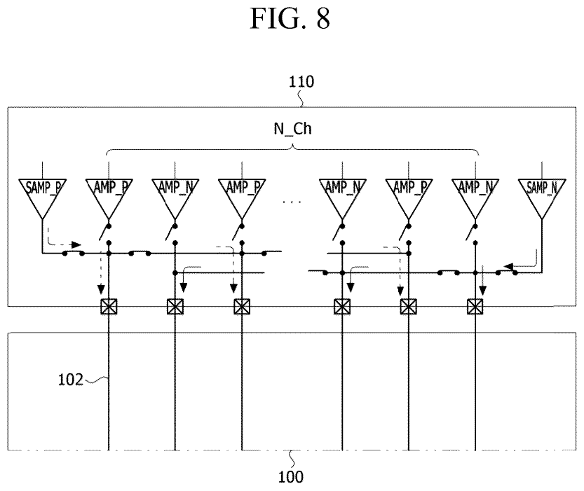

FIGS. 7 to 8 are diagrams for explaining the operation principle of the switch part shown in FIG. 6 according to an embodiment of the present disclosure.

Referring to FIG. 7, during the first driving mode (e.g., dynamic driving mode), the control circuit 110a-1 can turn on the first switch part and turn off the second switch part, so that the channel-by-channel output terminal of the voltage output circuit can be connected to the corresponding data line.

In this situation, the control circuit 110a-1 can block the bias current applied to the positive second amplifier SAMP_P in the positive voltage maintenance circuit 110c-1a and the negative second amplifier SAMP_N in the negative voltage maintenance circuit 110c-1b to deactivate the positive second amplifier SAMP_P and the negative second amplifier SAMP_N.

Referring to FIG. 8, during the second driving mode (e.g., low power/static driving mode), the control circuit 110a-1 can turn on the second switch part and turn off the first switch part, so that output terminals (such as the single output terminal of the positive second amplifier SAMP_P and the single output terminal of negative second amplifier SAMP_N) of the voltage maintenance circuit can be connected in common to all data lines.

In this situation, the control circuit 110a-1 can block the bias current applied to all amplifiers AMP_P and AMP_N in the voltage output circuit 110b-1 to deactivate all amplifiers AMP_P and AMP_N.

In an embodiment, the data driver is composed of the voltage output circuit and the voltage maintenance circuit, and either the voltage output circuit or the voltage maintenance circuit can be selected and used according to the pattern of the input image. For example, the voltage output circuit can be selected and used during the first driving mode when a dynamic image with data changes is input (e.g., moving video), and the voltage maintenance circuit can be connected and used during the second driving mode when a static image with no data changes is input (e.g., still image, static menus, etc.).

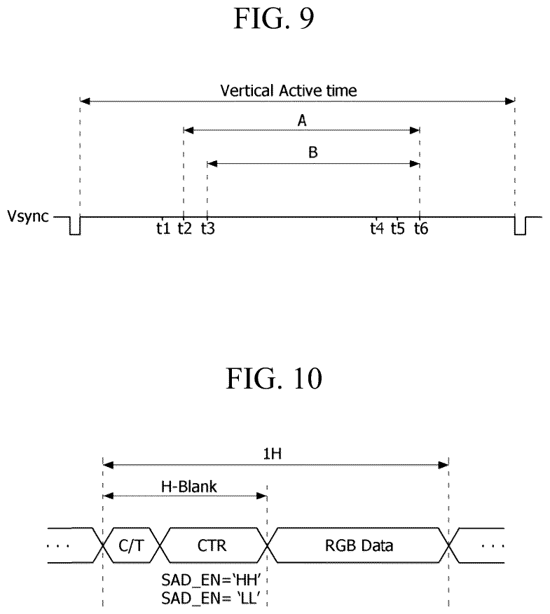

FIGS. 9 to 11 are diagrams for explaining the operation principle of the second driving mode (e.g., low power/static driving mode) according to an embodiment

Referring to FIGS. 9 to 11, in the embodiment, the data driver can be switched between the first driving mode and the second driving mode in each frame.

To switch the data driver from the first driving mode (e.g., dynamic driving mode) to the second driving mode (e.g., low power/static driving mode), as shown in FIG. 9, the data driver can be driven in the first driving mode for a predetermined horizontal times and then switched to the second driving mode, and to switch from the second driving mode to the first driving mode, the first amplifiers for the first driving mode can be activated for a predetermined horizontal times (e.g., a pre-activation period or priming period) and then switched to the first driving mode.

In this situation, before switching from the first driving mode to the second driving mode or from the second driving mode to the first driving mode, the timing controller can transmit data packets to the data driver.

The data packets can include clock training data C/T, control data CTR, and pixel data RGB Data. Mode information SAD_EN for activating or deactivating the second driving mode can be included in the control data that is transmitted in the horizontal blank interval H-Blank before the pixel data RGB Data is transmitted. As shown in FIG. 10, when the mode information SAD_EN is set to ‘HH’, it indicates the activation of the second driving mode (e.g., low power/static driving mode), and when the mode information SAD_EN is set to ‘LL’, it indicates the deactivation of the second driving mode. Here, the deactivation of the second driving mode can mean the activation of the first driving mode (e.g., dynamic driving mode). For example, the first driving mode and the second driving mode can be mutually exclusive.

An example of switching from the first driving mode to the second driving mode and then back to the first driving mode as shown in FIG. 9 will be explained as follows.

In FIG. 9, an interval A can be a portion where a static image is input, and an interval B can be a portion where the second driving mode is driven. The reason for the time difference between the interval A and the interval B is to pre-charge the data lines by the data voltage of the still image at the beginning part of the interval A.

First, while driving in the first driving mode, mode information SAD_EN set to ‘HH’ is transmitted 3H ahead (t1˜t2) from the start point t3 of driving in the second driving mode, and after driving in the first driving mode for 3H (t2˜t3) before the start point, the data driver can be switched to the second driving mode.

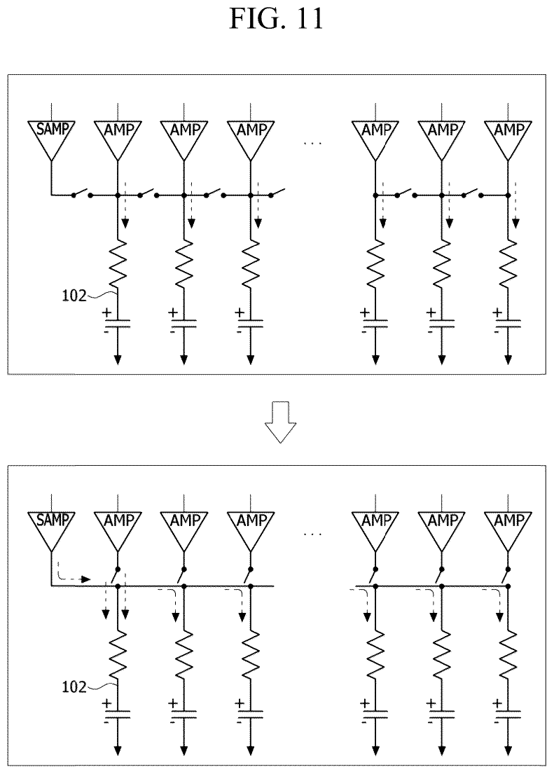

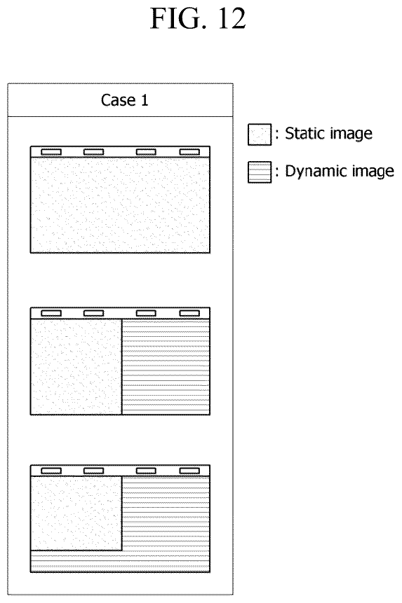

In this situation, as shown in FIGS. 9 and 11, when driving in the first driving mode during 3H (t2˜t3) before the start point, the voltage applied from the voltage output circuit to each data line is pre-charged, and after the start point (t3) of driving in the second driving mode, the voltage charged in each data line can be maintained by the voltage applied from the voltage maintenance circuit.

Thereafter, while driving in the second driving mode, mode information SAD_EN set to ‘LL’ is transmitted 3H ahead (t4˜t5) from the start point (t6) of driving in the first driving mode, and after all channel-by-channel amplifiers are activated during 3H (t5˜t6) ahead from the start point (t6), the data driver can be switched to the first driving mode.

Here, an example of connecting the voltage output circuit or activating the first amplifiers for 3H before switching between the first driving mode and the second driving mode is explained, but it is not necessarily limited thereto. The voltage output circuit can be connected or the first amplifiers can be activated for a period of at least 1H or more, and in the situation of 3H or more, stable switching can be possible. For example, the method can provide for smoothly transitioning between a first driving mode (e.g., dynamic image or video) and a second driving mode (e.g., static image) using a preparatory period to ensure stability and improve image quality, such as 3 horizontal lines (3H). To switch from the first mode to the second mode, mode change information can be sent 3H in advance, and during this interval, the display can continue in the first mode but uses its circuitry to pre-charge the data lines with the incoming static image's voltage before formally switching to the second mode, where a dedicated circuit then maintains this voltage (e.g., SAMP). Conversely, when returning from the second mode to the first mode, different mode information can also be sent 3H ahead, and during this preparatory 3H window before the switch, the amplifiers for the first driving mode can be fully activated. This preparatory phase of at least 1H (e.g., 3H or more) can allow for stable switching between the driving modes.

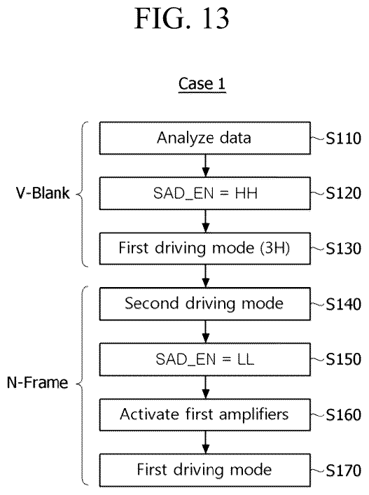

FIGS. 12 to 13 are diagrams for explaining a situation in which the second driving mode is initiated according to an embodiment of the present disclosure.

Referring to FIGS. 12 to 13, various examples where a static image is input from the first line of the frame are shown, e.g., the data driver can be driven in the second driving mode at the start point of the frame.

During the vertical blank V-Blank interval, the timing controller can analyze the image data and determine the area where the static image is input based on the analysis result (S110).

For example, the timing controller can determine an area where predetermined data, e.g., white data or black data, is input consistently in each frame as an area where a static image is input, and can determine the remaining area except for the static image as a dynamic area. Such a static area can be a blank or letterbox, or a menu in the screen, but is not limited thereto.

As another example, the timing controller can compare the previous frame and the current frame, and determine an area where there is a change in data as an area where a dynamic image is input, and an area where there is no change in data as an area where a static image is input based on the comparison result.

In the situation where there is an area where a static image is input from the first line of the frame, the timing controller can transmit mode information set to activate the second driving mode, for example, ‘SAD_EN=HH’, to the data driver (S120).

The data driver can be driven in the first driving mode for 3H based on the mode information, that is, it can be driven to connect all amplifiers of the voltage output circuit to the data line (S130).

When an (N)th frame, N-Frame, interval starts, the data driver can be switched to the second driving mode, that is, the data lines connected to all first amplifiers of the voltage output circuit are released, and switched to connect all data lines to the second amplifier of the voltage maintenance circuit (S140). At this time, all first amplifiers of the voltage output circuit can be deactivated, resulting in reduced current consumption.

Thereafter, if there is an area where a dynamic image is input, the timing controller can transmit mode information set to activate the first driving mode, for example, ‘SAD_EN=LL’, to the data driver (S150).

Based on the mode information, the data driver can activate all first amplifiers by applying a predetermined bias voltage to all first amplifiers of the voltage output circuit for 3H (S160). The reason for activating the first amplifiers in advance during 3H before switching to the first driving mode is that if the first amplifiers are activated after switching to the first driving mode, a delay time can occur for the first amplifiers to operate normally, which could briefly impair image quality. Thus, by using the pre-charging period (e.g., 3H), any drop in quality or noticeably transition by the viewer can be prevented.

The data driver can be driven in the first driving mode by connecting the first amplifiers of the voltage output circuit to the data lines (S170). In this situation, the second amplifier in the voltage maintenance circuit may not only be disconnected from the data line but also be deactivated as the bias current is blocked.

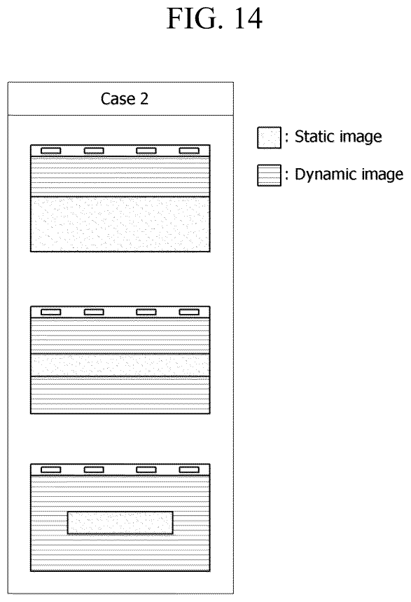

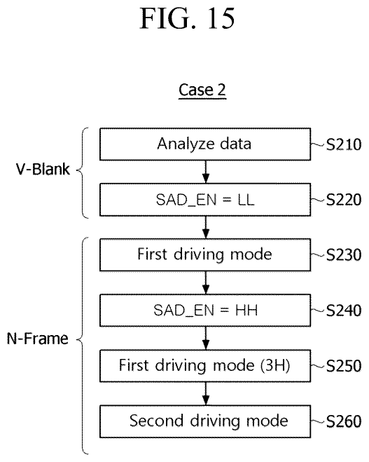

FIGS. 14 to 15 are diagrams for explaining a situation in which the first driving mode is initiated according to an embodiment of the present disclosure.

Referring to FIGS. 14 to 15, various examples where a dynamic image is input from the first line of the frame are shown, e.g., the data driver can be driven in the first driving mode at the start point of the frame.

During the vertical blank V-Blank interval, the timing controller can analyze the image data and determine an area where the data driver is capable of driving in the second driving mode based on the analysis result (S210).

In the situation where an area where a dynamic image is input is set from the first line of the frame, the timing controller can transmit mode information set to deactivate the second driving mode, for example, ‘SAD_EN=LL’, to the data driver (S220).

When an (N)th frame, N-Frame, interval starts, the data driver can be driven in the first driving mode based on the mode information (S230).

Thereafter, if there is an area where a static image is input, the timing controller can transmit mode information set to activate the second driving mode, for example, ‘SAD_EN=HH’, to the data driver (S240).

Based on the mode information, the data driver can be driven in the first driving mode for 3H, that is, it can be driven to connect all amplifiers of the voltage output circuit to the data line (S250).

After being driven in the first driving mode for 3H, the data driver can be switched to the second driving mode, that is, the data lines connected to all amplifiers of the voltage output circuit are released, and switched to connect all data lines to the amplifier of the voltage maintenance circuit (S260).

Although the embodiments of the present disclosure have been described in more detail with reference to the accompanying drawings, the present disclosure is not limited thereto and can be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

What is claimed is:

1. A data driver comprising:
a voltage output circuit including a plurality of digital-to-analog converters configured to convert pixel data into analog data voltages, and a plurality of first amplifiers configured to amplify the analog data voltages and output amplified analog data voltages to a plurality of data lines;
a voltage maintenance circuit including a second amplifier configured to amplify a predetermined data voltage into an amplified predetermined data voltage, and output the amplified predetermined data voltage to the plurality of data lines in common; and
a selection circuit configured to selectively connect either the voltage output circuit or the voltage maintenance circuit to the plurality of data lines based on a pattern of the pixel data.

2. The data driver according to claim 1, wherein the second amplifier is connected to an output of one of the plurality of digital-to-analog converters.

3. The data driver according to claim 1, further comprising:
a control circuit configured to analyze the pixel data input from a timing controller, and control the selection circuit based on the pattern of the pixel data.

4. The data driver according to claim 3, wherein the control circuit is further configured to:
block a bias current from being applied to the second amplifier to deactivate the second amplifier when the voltage output circuit is connected to the plurality of data lines.

5. The data driver according to claim 3, wherein the control circuit is further configured to:
block a bias current from being applied to the plurality of first amplifiers to deactivate the first amplifiers when the voltage maintenance circuit is connected to the plurality of data lines.

6. The data driver according to claim 3, wherein the control circuit is further configured to:
operate in a first driving mode that connects the voltage output circuit to the plurality of data lines when the pixel data is a dynamic image, and
operate in a second driving mode that connects the voltage maintenance circuit to the plurality of data lines when the pixel data is a static image.

7. The data driver according to claim 6, wherein the control circuit is further configured to:
operate in the first driving mode for a predetermined horizontal times from a start point for input of the static image, and then switch to the second driving mode that connects the voltage maintenance circuit to the plurality of data lines.

8. The data driver according to claim 6, wherein the control circuit is further configured to:
activate the plurality of first amplifiers by applying a bias current to the plurality of first amplifiers for a predetermined horizontal times before input of the static image ends.

9. The data driver according to claim 1, wherein the plurality of first amplifiers include a plurality of positive first amplifiers and a plurality of negative first amplifiers, and
wherein the voltage maintenance circuit includes:
a positive second amplifier configured to amplify a data voltage output from a digital-to-analog converter connected to one of the plurality of positive first amplifiers; and
a negative second amplifier configured to amplify a data voltage output from a digital-to-analog converter connected to one of the plurality of negative first amplifiers.

10. The data driver according to claim 1, wherein the selection circuit includes:
a first switch part connected between output terminals of the plurality of first amplifiers and the plurality of data lines; and
a second switch part connected between an output terminal of the second amplifier and a data line among the plurality of data lines, and connected between remaining data lines among the plurality of data lines.

11. A display device, comprising:
a pixel array including a plurality of data lines, a plurality of gate lines, and a plurality of pixel circuits;
a data driver configured to output data voltages to the plurality of data lines;
a gate driver configured to output gate signals to the plurality of gate lines; and
a timing controller configured to control the data driver and the gate driver,
wherein the data driver includes:
a voltage output circuit including a plurality of digital-to-analog converters configured to convert pixel data into analog data voltages, and a plurality of first amplifiers configured to amplify the analog data voltages and output amplified analog data voltages to the plurality of data lines;
a voltage maintenance circuit including a second amplifier configured to amplify a predetermined data voltage into an amplified predetermined data voltage, and output the amplified predetermined data voltage to the plurality of data lines in common; and
a selection circuit configured to selectively connect either the voltage output circuit or the voltage maintenance circuit to the plurality of data lines based on a pattern of the pixel data.

12. The display device according to claim 11, wherein the second amplifier is connected to an output of one of the plurality of digital-to-analog converters.

13. The display device according to claim 11, further comprising:
a control circuit configured to analyze the pixel data input from the timing controller, and control the selection circuit based on the pattern of the pixel data.

14. The display device according to claim 13, wherein the control circuit is further configured to:
operate in a first driving mode that connects the voltage output circuit to the plurality of data lines when the pixel data is a dynamic image, and
operate in a second driving mode that connects the voltage maintenance circuit to the plurality of data lines when the pixel data is a static image.

15. The display device according to claim 14, wherein the timing controller is further configured to transmit data packets with mode information corresponding to the second driving mode to the data driver before a start point for input of static image, and
wherein the control circuit is further configured to operate in the first driving mode for a predetermined horizontal times from the start point for input of the static image, and then to switch to the second driving mode that connects the voltage maintenance circuit to the plurality of data lines.

16. The display device according to claim 14, wherein the timing controller is further configured to transmit data packets with mode information corresponding to the first driving mode to the data driver before input of the static image ends, and
wherein the control circuit is further configured to activate the plurality of first amplifiers by applying a bias current to the plurality of first amplifiers for a predetermined horizontal times before the input of the static image ends.

17. The display device according to claim 11, wherein the plurality of first amplifiers include a plurality of positive first amplifiers and a plurality of negative first amplifiers, and
wherein the voltage maintenance circuit includes:
a positive second amplifier configured to amplify a data voltage output from a digital-to-analog converter connected to one of the plurality of positive first amplifiers; and
a negative second amplifier configured to amplify a data voltage output from a digital-to-analog converter connected to one of the plurality of negative first amplifiers.

18. The display device according to claim 11, wherein the selection circuit includes:
a first switch part connected between output terminals of the plurality of first amplifiers and the plurality of data lines; and
a second switch part connected between an output terminal of the second amplifier and a data line among the plurality of data lines, and connected between remaining data lines among the plurality of data lines.

19. A display device, comprising:
a display panel including a plurality of subpixels configured to display an image based on pixel data;
a plurality of digital-to-analog converters configured to convert the pixel data into analog data voltages;
a plurality of first amplifiers configured to amplify the analog data voltages and output amplified analog data voltages to a plurality of data lines connected to the plurality of subpixels;
a second amplifier configured to amplify a predetermined data voltage into an amplified predetermined data voltage, and output the amplified predetermined data voltage to the plurality of data lines in common; and
a controller configured to:
in response to activation of a first mode, connect the plurality of first amplifiers to the plurality of data lines and disconnect the second amplifier from the plurality of data lines, and
in response to activation of a second mode, connect the second amplifier to the plurality of data lines in common and disconnect the plurality of data lines from the plurality of data lines.

20. The display device according to claim 19, wherein the second amplifier is larger than each of the plurality of first amplifiers, and the second amplifier is configured to deliver a wider range of electrical current compared to each of the plurality of first amplifiers.
